(19) United States
(12) Patent Application Publication
(10) Pub. No.: US 2022/0209463 A1
(43) Pub. Date: Jun. 30, 2022

(54) ELECTRICAL CONNECTOR AND ELECTRICAL EQUIPMENT

(71) Applicant: Huawei Digital Power Technologies Co., Ltd., Shenzhen (CN)

(72) Inventors: Peixing CHEN, Dongguan (CN); Jingxiao CHEN, Shanghai (CN); Fugao ZHAO, Dongguan (CN); Jian GONG, Dongguan (CN); Xiangtao MENG, Dongguan (CN)

(21) Appl. No.: 17/565,030

(22) Filed: Dec. 29, 2021

(30) Foreign Application Priority Data
Dec. 30, 2020 (CN) 202011605114.0

(51) Int. Cl. H01R 13/639; H01R 13/635

(52) U.S. Cl. CPC H01R 13/639; H01R 13/635

(57) ABSTRACT

An electrical connector includes a first plug-connection module and a second plug-connection module, and the first plug-connection module and the second plug-connection module fit with each other through a plug-connection in a first direction. The first plug-connection module includes a first housing component and a first wiring portion. The second plug-connection module includes a second housing component, a second wiring portion, and a sliding conductor. A locking mechanism and a trigger mechanism are disposed between the first plug-connection module and the second plug-connection module; and while the locking mechanism is in a locked state, the locking mechanism locks the sliding conductor and the first wiring portion, to keep the sliding conductor connected to the first wiring portion. An elastic reset member is disposed between the second housing component and the sliding conductor.

### CROSS-REFERENCE TO RELATED APPLICATIONS

This application claims priority to Chinese Patent Application No. 202011605114.0, filed on Dec. 30, 2020, which is hereby incorporated by reference in its entirety.

### TECHNICAL FIELD

This application relates to the field of connector technologies, and in particular, to an electrical connector and electrical equipment.

### BACKGROUND

In an existing data center field, a power frequency transformer is commonly used to implement transformation of medium-voltage power distribution into low-voltage power distribution. When the power frequency transformer is replaced with a solid state transformer, a power supply link architecture can be effectively simplified, thereby improving power supply efficiency and reducing a volume. In a current data center system, medium-voltage power distribution usually has no hot swap maintenance function. When a transformation system is maintained, to prevent an electric arc generated in a plugging/unplugging process of an electrical connector from injuring a person or damaging a device, usually, the transformation system can be maintained only after being completely powered off. Therefore, when a function module is faulty, the entire system device needs to be powered off, other function modules of the system device cannot operate normally, and the entire system device starts slowly after being repaired, causing an increase in maintenance time.

### SUMMARY

This application provides an electrical connector and electrical equipment. The electrical connector has a hot swap function, and can implement a hot swap in a power-on case.

According to a first aspect, this application provides an electrical connector, including a first plug-connection module and a second plug-connection module. The first plug-connection module fits with the second plug-connection module through plug-connection in a first direction. The first plug-connection module includes a first housing component, and a first wiring portion is disposed in the first housing component. The second plug-connection module includes a second housing component, a second wiring portion and a sliding conductor are disposed in the second housing component, the sliding conductor is slidably connected to the second wiring portion in the first direction, and the second wiring portion is connected to the second housing component through fastening. A locking mechanism and a trigger mechanism are disposed between the first plug-connection module and the second plug-connection module; and when the locking mechanism is in a locked state, the locking mechanism locks the sliding conductor and the first wiring portion, to keep the sliding conductor connected to the first wiring portion; or when the locking mechanism is in an unlocked state, locking between the sliding conductor and the first wiring portion is released. An elastic reset member is disposed between the second housing component and the sliding conductor; and when the first housing component and the second housing component are moved away from each other to a preset position, the trigger mechanism triggers the locking mechanism to enable the locking mechanism to be in the unlocked state, and the elastic reset member is in a force accumulation state to drive the sliding conductor to move in the first direction, to separate the sliding conductor from the first wiring portion.

The electrical connector provided in this embodiment of this application includes the first plug-connection module, the second plug-connection module, the locking mechanism, the trigger mechanism, and the elastic reset member. The first plug-connection module is plug-connected to the second plug-connection module in the first direction. The first plug-connection module includes the first housing component and the first wiring portion, the second plug-connection module includes the second housing component, the second wiring portion, and the sliding conductor, one end of the sliding conductor is slidably connected to the second wiring portion, and the sliding conductor and the second wiring portion can slide relative to each other in the first direction. After the first plug-connection module is plugged into the second plug-connection module, the locking mechanism is in the locked state. In this case, the locking structure locks the sliding conductor and the first wiring portion, so that the sliding conductor and the first wiring portion are in a connected state. When the first plug-connection module and the second plug-connection module are in an initial phase of a separation process, the first housing component and the second housing component move away relative to each other, but the preset position is not reached between the first housing component and the second housing component. In this case, the sliding conductor and the first wiring portion are in the connected state. When the first housing component and the second housing component are moved away from each other to the preset position, the trigger mechanism triggers the locking mechanism to unlock the locking mechanism. In this case, the elastic reset member is in the force accumulation state, and when the locking mechanism is unlocked, the elastic reset member drives the sliding conductor to move in a direction away from the first wiring portion in the first direction, to separate the sliding conductor from the first wiring portion. In the separation process, because the first housing component has been separated from the second housing component by a specific distance, the sliding conductor can fast return to an initial position in the second housing component at the moment when the locking mechanism is unlocked, so that the sliding conductor is fast separated from the first wiring portion, to prevent an electric arc generated between the sliding conductor and the first wiring portion from damaging a person or a device. Therefore, the electrical connector in this application can implement a hot swap in a driving case, to implement fast separation between the first plug-connection module and the second plug-connection module, so that when only one function module needs to be overhauled and maintained, an entire system device may not be necessarily powered off, thereby shortening maintenance time and improving maintenance efficiency.

In a possible implementation of this application, when the first housing component and the second housing component are moved away from each other to the preset position, the trigger mechanism is triggered, and after the sliding conductor is separated from the first wiring portion, a distance between the first wiring portion and the sliding conductor is greater than an arc extinguishing distance between the first wiring portion and the sliding conductor. Therefore, arc extinguishing is implemented when the sliding conductor is separated from the first wiring portion.

In a possible implementation of this application, the locking mechanism includes a locking hole, a first convex lug, and an elastic body. The locking hole is disposed in the first housing component. The first convex lug is connected to the sliding conductor, the first convex lug protrudes in a second direction and can move in the second direction, and the second direction is perpendicular to the first direction. When the first convex lug is inserted into the locking hole, the locking mechanism is in the locked state; or when the first convex lug is detached from the locking hole, the locking mechanism is in the unlocked state. The elastic body is configured to provide the first convex lug with a force for enabling the first convex lug to move in a direction oppositely to a surface of the sliding conductor.

The elastic body is disposed to provide the first convex lug with a force for enabling the first convex lug to move in the second direction. Under the action of the force, the first convex lug can be inserted into the locking hole to lock the sliding conductor and the first wiring portion. In addition, when the first convex lug receives pressure to move in a direction near the sliding conductor, the first convex lug can press the elastic body, to be detached from the locking hole to enter the unlocked state. Therefore, the locking mechanism of the structure is characterized by a simple structure and convenient locking and unlocking.

In a possible implementation of this application, when the locking hole is specifically disposed, the locking hole is a through hole or a blind hole.

In a possible implementation of this application, the trigger mechanism includes a second convex lug and a guide portion. The second convex lug protrudes in the second direction and is connected to the sliding conductor, and the second convex lug is disposed through fastening relative to the first convex lug, so that the first convex lug and the second convex lug can synchronously move. A protrusion height of the second convex lug is greater than a protrusion height of the first convex lug, and a height difference between the second convex lug and the first convex lug is greater than a height of the locking hole. The guide portion is formed in the second housing component. In a process in which the first plug-connection module is detached from the second plug-connection module, when the first housing component and the second housing component are moved away from each other to the preset position, the guide portion abuts against the second convex lug to press the second convex lug to an unlocked position, and the second convex lug drives the first convex lug to detach the first convex lug from the locking hole.

In the structure, at the preset position, the guide portion can apply pressure to the second convex lug, and in a process in which the second convex lug operates toward the sliding conductor, the second convex lug drives the first convex lug to move together, to detach the first convex lug from the locking hole.

In a possible implementation of this application, the locking mechanism further includes a lock body, and the first convex lug and the second convex lug may be both fastened to the lock body. The lock body is connected to the sliding conductor, the elastic body is disposed between the lock body and the sliding conductor, and the lock body can move relative to the sliding conductor in the second direction. The elastic body can apply an elastic force to the lock body, to also drive the first convex lug and the second convex lug to move in a process in which the lock body moves. The lock body is disposed, so that movement stability of the first convex lug and the second convex lug can be improved.

In an embodiment of this application, a base is connected to a peripheral side surface of the sliding conductor through fastening, a sliding slot extending in the second direction is disposed in the base, and the lock body slidably fits with the base through the sliding slot. The lock body slidably fits with the sliding slot of the base, so that the lock body can move in the second direction in the sliding slot, thereby further improving movement stability of the lock body.

In an embodiment of this application, when the elastic body is specifically disposed, the elastic body is disposed between the lock body and the base, and two ends of the elastic body respectively abut against the lock body and the base, so that the elastic body is always in the force accumulation state, to provide power for movement of the lock body in a direction away from the sliding conductor.

In an embodiment of this application, a limiting mechanism is disposed between the sliding slot and the lock body, and the limiting mechanism is configured to limit a maximum sliding stroke of the lock body relative to the base. The limiting mechanism is disposed, so that movement of the lock body in the second direction can be completely limited in the sliding slot, to prevent the lock body from being detached from the sliding slot, thereby improving operating reliability of the lock body.

In an embodiment of this application, when the first wiring portion is specifically disposed, the first wiring portion may include a pin, and a contact is disposed at an end that is of the pin and that is configured to be connected to the sliding conductor. A material of the contact is a high-temperature-resistant material, such as copper or a copper alloy. The contact of the high-temperature-resistant copper or copper alloy material is disposed, so that a high-temperature-resistant characteristic of the first wiring portion can be improved, to improve a service life of the pin.

In an embodiment of this application, the first housing component includes a first insulation housing and a first guide sleeve that is disposed in the first insulation housing and that is connected to the first insulation housing through fastening, and one end of the first wiring portion is disposed in the first guide sleeve. The first insulation housing is configured to ensure insulation performance between the first plug-connection module and the outside, and the first guide sleeve can be configured to provide a relatively strong high-temperature-resistant characteristic, to prevent the first insulation housing from being damaged under a condition of a high temperature.

In a possible implementation of this application, an arc extinguishing chamber is disposed in the first guide sleeve, and an end that is of the first wiring portion and that is configured to be connected to the sliding conductor is located in the arc extinguishing chamber. The arc extinguishing chamber is disposed, so that an electric arc generated in a process in which the first wiring portion is plug-connected to or separated from the sliding conductor is extinguished in the arc extinguishing chamber, thereby improving safety of the electrical connector.

When the arc extinguishing chamber is specifically disposed, in a possible implementation of this application, a plurality of arc extinguishing grids spaced at intervals are disposed on an inner surface of the arc extinguishing chamber. The arc extinguishing grid may be an annular protrusion circumferentially disposed along an inner surface of the first guide sleeve. Specifically, a cross-section of the arc extinguishing grid may be rectangular, trapezoidal, or arc-shaped. The arc extinguishing grids are disposed, so that an electric arc generated in the arc extinguishing chamber can be cut from one long arc into a plurality of short arcs, to implement short-arc-based arc extinguishing.

In a possible implementation of this application, a first sliding hole that fits with the first wiring portion is disposed at an end that is of the sliding conductor and that is configured to be connected to the first wiring portion. The first sliding hole can be connected to the pin of the first wiring portion through fitting, and the pin can slide in the first sliding hole, to implement plug-connection and separation between the sliding conductor and the first wiring portion.

In a possible implementation of this application, the second housing component includes a second insulation housing, the second wiring portion is disposed in the second insulation housing, and a second sliding hole is disposed at an end that is of the second wiring portion and that is configured to be connected to the sliding conductor. A wiring terminal may be disposed on a side that is of the second wiring portion and that is away from the sliding conductor, and the wiring terminal may protrude from the second insulation housing and is configured to be connected to an external line. The sliding conductor can be plugged into the second sliding hole. When the locking mechanism locks the sliding conductor and the first wiring portion, the sliding conductor can move relative to the second wiring portion through the second sliding hole.

In a possible implementation of this application, the second housing component includes a second guide sleeve, the second guide sleeve is disposed outside the sliding conductor through encasing, and the sliding conductor is slidably connected to the second guide sleeve in the first direction. The second guide sleeve may be prepared by using a high-temperature-resistant material, to improve a high-temperature-resistant characteristic of the second housing component.

In a possible implementation of this application, a guide hole is disposed on a peripheral side surface of the second guide sleeve, the guide hole is a strip-shaped structure, the guide hole extends in the first direction, and the base connected to the sliding conductor through fastening penetrates through the guide hole. The guide hole is disposed, so that when the sliding conductor moves relative to the second guide sleeve in the first direction, the base connected to the sliding conductor can move in the guide hole together with the sliding conductor.

In a possible implementation of this application, a stop protrusion is disposed at an end portion of the end that is of the sliding conductor and that is configured to be connected to the first wiring portion, to limit a position of the second guide sleeve relative to the sliding conductor in the first direction. The stop protrusion is disposed, so that the sliding conductor can be prevented from completely entering the second guide sleeve, to facilitate connection between the first wiring portion and the sliding conductor in a process in which the first plug-connection module is plugged into the second plug-connection module.

In a possible implementation of this application, one end of the elastic reset member is connected to the second guide sleeve, and the other end of the elastic reset member is connected to the sliding conductor. Specifically, a first fastener is disposed on an outer peripheral surface of the second guide sleeve, a second fastener is disposed on the base connected to the sliding conductor, and two ends of the elastic reset member are respectively connected to the first fastener and the second fastener. Therefore, when the sliding conductor moves relative to the second guide sleeve in the first direction, the elastic reset member can be stretched to provide a force for reciprocation of the sliding conductor.

In a possible implementation of this application, the first housing component includes a first metal layer and a second metal layer that are embedded in the first insulation housing, the second metal layer is disposed inside the first insulation housing, the first metal layer is disposed near an outer surface of the first insulation housing relative to the second metal layer, the first metal layer is connected to a zero potential, and the second metal layer is equipotentially connected to the first wiring portion.

Because the first wiring portion is connected to a medium-voltage potential, and an environment in which the first wiring portion is located is an unsealed environment, air near the first wiring portion in the first insulation housing is also a medium-voltage environment. To prevent partial discharge from being caused by an internal and external air voltage difference, the first metal layer and the second metal layer may be pre-disposed in the first insulation housing. The first metal layer may be connected to the zero potential, and the second metal layer is equipotentially connected to the first wiring portion. Therefore, the internal and external voltage difference of the first insulation housing can be applied to the first insulation housing between the first metal layer and the second metal layer, to prevent air partial discharge.

In a possible implementation of this application, the second housing component includes a third metal layer and a fourth metal layer that are embedded in the second insulation housing, the fourth metal layer is disposed inside the second insulation housing, the third metal layer is disposed near an outer surface of the second insulation housing relative to the fourth metal layer, the third metal layer is connected to a zero potential, and a potential of the fourth metal layer is equipotentially connected to the second wiring portion.

Similarly, because the sliding conductor and the second wiring portion are connected to a medium-voltage potential, and an environment in which the sliding conductor and the second wiring portion are located is an unsealed environment, air near the second wiring portion in the second insulation housing is also a medium-voltage environment. To prevent partial discharge from being caused by an internal and external air voltage difference, the third metal layer and the fourth metal layer may be pre-disposed in the second insulation housing. The third metal layer may be connected to the zero potential, and the fourth metal layer is equipotentially connected to the second wiring portion. Therefore, the internal and external voltage difference of the second insulation housing can be applied to the second insulation housing between the third metal layer and the fourth metal layer, to prevent air partial discharge.

According to a second aspect, this application further provides electrical equipment. The electrical equipment includes a first circuit unit, a second circuit unit, and the electrical connector in the first aspect of this application. The first wiring portion is connected to the first circuit unit, and the second wiring portion is connected to the second circuit unit.

The electrical equipment in this application includes the electrical connector in the first aspect of this application. When the electrical connector in this application has a hot swap function, a function module corresponding to the first circuit unit or the second circuit unit in the electrical equipment in this application can be overhauled under a condition of a weak current.

### BRIEF DESCRIPTION OF DRAWINGS

FIG. 1 is a schematic diagram of a structure of an electrical connector according to an embodiment of this application;

FIG. 2 is a schematic exploded diagram of a structure of a first plug-connection module according to an embodiment of this application;

FIG. 3 is a schematic cross-sectional diagram of a structure of a first plug-connection module according to an embodiment of this application;

FIG. 4 is a schematic cross-sectional diagram of a structure of a first guide sleeve according to an embodiment of this application;

FIG. 5 is a schematic exploded diagram of a structure of a second plug-connection module according to an embodiment of this application;

FIG. 6 is a schematic cross-sectional diagram of a structure of a second plug-connection module according to an embodiment of this application;

FIG. 7 is a schematic cross-sectional diagram of a structure in which a first plug-connection module is plugged into a second plug-connection module according to an embodiment of this application;

FIG. 8 is a schematic diagram of a structure of a sliding conductor according to an embodiment of this application;

FIG. 9 is a schematic diagram of a structure of a second wiring portion according to an embodiment of this application;

FIG. 10 is a schematic cross-sectional diagram of a structure in which a first plug-connection module and a second plug-connection module are in a separated state according to an embodiment of this application;

FIG. 11 is a schematic exploded diagram of a structure of a locking mechanism according to an embodiment of this application;

FIG. 12 is a schematic diagram of a structure in which a first convex lug is detached from a locking hole according to an embodiment of this application;

FIG. 13 is a schematic diagram of a structure of a second guide sleeve according to an embodiment of this application;

FIG. 14 is a schematic cross-sectional diagram of a structure of a connection relationship of an elastic reset member according to an embodiment of this application;

FIG. 15 is a schematic diagram of a structure of a connection relationship of an elastic reset member according to an embodiment of this application;

FIG. 16 is a schematic diagram of a structure in which a sliding conductor returns to an initial state according to an embodiment of this application; and

FIG. 17 is a schematic diagram of a structure in which a first insulation housing and a second insulation housing of an electrical connector are hid according to an embodiment of this application.

Reference numerals: 1—first plug-connection module; 11—first housing component; 111—first insulation housing; 111a—gap; 112—first guide sleeve; 112a—first chamber; 112b—second chamber; 1121—arc extinguishing grid; 12—first wiring portion; 121—pin; 122—contact; 113—first metal layer; 114—second metal layer; 2—second plug-connection module; 21—second housing component; 211—second insulation housing; 212—second guide sleeve; 2121—guide hole; 2122—first fastener; 213—third metal layer; 214—fourth metal layer; 22—second wiring portion; 221—second sliding hole; 222—second split groove; 223—wiring terminal; 23—sliding conductor; 231—first sliding hole; 232—first split groove; 233—stiffener; 234—mounting hole; 24—base; 241—sliding slot; 242—mounting post; 243—second fastener; 3—locking mechanism; 31—locking hole; 32—first convex lug; 33—elastic body; 34—lock body; 35—limiting mechanism; 351—limiting hole; 352—limiting protrusion; 4—trigger mechanism; 41—guide portion; 42—second convex lug; and 5—elastic reset member.

### DESCRIPTION OF EMBODIMENTS

The following further describes this application in detail with reference to the accompanying drawings.

Terms used in the following embodiments are merely intended to describe specific embodiments, but are not intended to limit this application. The terms “one”, “a” and “this” of singular forms used in this specification and the appended claims of this application are also intended to include plural forms, for example, “one or more”, unless otherwise specified in the context clearly.

Reference to “an embodiment”, “some embodiments”, or the like described in this specification indicates that one or more embodiments of this application include a specific feature, structure, or characteristic described with reference to the embodiments. Therefore, in this specification, statements, such as “in an embodiment”, “in some embodiments”, “in some other embodiments”, and “in other embodiments”, that appear at different places do not necessarily mean referring to a same embodiment, instead, they mean “one or more but not all of the embodiments”, unless otherwise specifically emphasized. The terms “include”, “comprise”, “have”, and their variants all mean “include but are not limited to”, unless otherwise specifically emphasized.

In an existing data center system, a power frequency transformer is commonly used to implement transformation of medium-voltage power distribution into low-voltage power distribution. When the power frequency transformer is replaced with a solid state transformer, a power supply link architecture can be effectively simplified, thereby improving power supply efficiency and reducing a volume. In alternating current voltage levels, usually, a voltage lower than or equal to 1 kV is referred to as a low voltage, and a voltage higher than or equal to 10 kV and lower than or equal to 35 kV is referred to as a medium voltage. However, in a current data center system, medium-voltage power distribution usually has no hot swap maintenance function. To implement a swappable maintenance function, a corresponding electrical connector needs to be disposed for each function module in the medium-voltage power distribution for accessing a backbone circuit, to implement connection.

In an existing connection solution, in a manner, a medium-voltage circuit breaker is used as a swap mechanism. The swap mechanism of the structure cannot resist an electric arc generated by a medium-voltage hot swap, and a device needs to be powered off when a function module is maintained. In another manner, power-on/off control is implemented by using a control module. When a function module is maintained, a power-on current of the function module is cut off by using the control module, and then the function module is unplugged to maintain the function module. In a swap process in this manner, a current is almost zero, and only a voltage swap rather than a real hot swap is implemented. Therefore, if a modular hot swap needs to be implemented, a weak current that supports soft start inevitably needs to be internally provided for a module. In a medium-voltage scenario, an electric arc is generated due to the weak current in an actual swap process, causing damage to a terminal. Therefore, a current electrical connector has no fast hot swap function in a power-on case.

To resolve the foregoing problem, embodiments of this application provide an electrical connector, and the electrical connector can implement a hot swap in a power-on case, to improve maintenance efficiency.

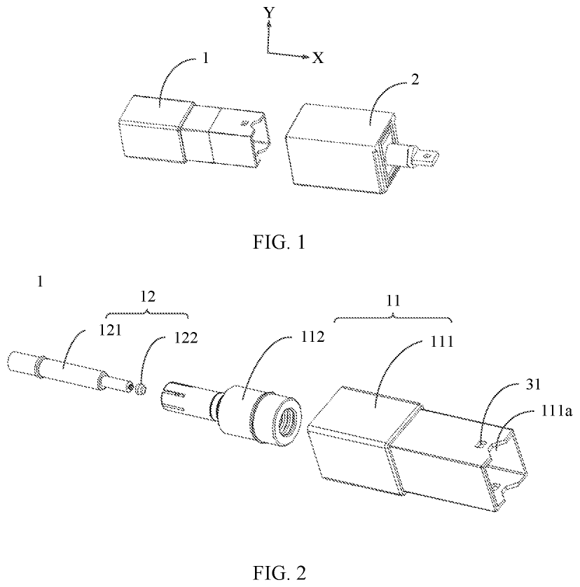

FIG. 1 is a schematic diagram of a structure of an electrical connector according to an embodiment of this application. As shown in FIG. 1, the electrical connector in this embodiment of this application includes a first plug-connection module 1 and a second plug-connection module 2, and the first plug-connection module 1 fits with the second plug-connection module 2 through plug-connection. In this application, a direction in which the first plug-connection module 1 is plug-connected to the second plug-connection module 2 may be defined as a first direction. The first direction may be, for example, an X direction shown in FIG. 1.

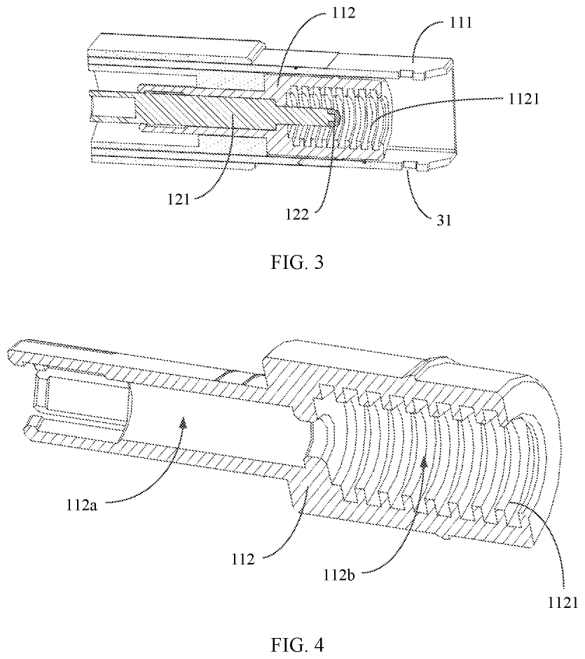

FIG. 2 is a schematic exploded diagram of a structure of the first plug-connection module 1 according to an embodiment of this application. FIG. 3 is a schematic cross-sectional diagram of a structure of the first plug-connection module 1 according to an embodiment of this application. Refer to FIG. 2 and FIG. 3. In an embodiment of this application, the first plug-connection module 1 includes a first housing component 11 and a first wiring portion 12, and the first wiring portion 12 is located inside the first housing component 11. The first housing component 11 includes a first insulation housing 111 and a first guide sleeve 112, and the first guide sleeve 112 is located in the first insulation housing 111 and is connected to the first insulation housing 111 through fastening.

FIG. 4 is a schematic cross-sectional diagram of a structure of the first guide sleeve 112 according to an embodiment of this application. As shown in FIG. 4, the first guide sleeve 112 is a hollow structure, and an internal chamber of the first guide sleeve 112 may be divided into a first chamber 112a and a second chamber 112b in the first direction. With reference to FIG. 1, in the direction in which the first plug-connection module 1 is plugged into the second plug-connection module 2, the second chamber 112b is located on a side near the second plug-connection module 2, and the first chamber 112a is located on a side away from the second plug-connection module 2. The first chamber 112a is configured to fasten the first wiring portion 12 through penetration, and the second chamber 112b is an arc extinguishing chamber. A plurality of arc extinguishing grids 1121 spaced at intervals are disposed on an inner surface of the arc extinguishing chamber.

The arc extinguishing grid 1121 may be made of high-temperature-resistant metal or a non-conductive high-temperature-resistant material. When the arc extinguishing grid 1121 is made of high-temperature-resistant metal, an electric arc in the arc extinguishing chamber is extinguished by using a short-arc-based arc extinguishing principle. When the arc extinguishing grid 1121 is made of a non-conductive high-temperature-resistant material such as ceramic, an instantaneous high temperature generated by an electric arc may be resisted by using a high-temperature-resistant characteristic of the non-conductive high-temperature-resistant material such as ceramic.

As an example description, refer to FIG. 4. The arc extinguishing grid 1121 may be an annular protrusion circumferentially disposed along an inner surface of the first guide sleeve 112. There may be a plurality of annular protrusions. It may be understood that a cross-section of the arc extinguishing grid 1121 may be, for example, rectangular, trapezoidal, or arc-shaped. When the arc extinguishing grid 1121 is an annular protrusion, a cross-section of the arc extinguishing grid 1121 is a cut-off surface obtained after the arc extinguishing grid 1121 is cut along a radial direction of the arc extinguishing grid 1121.

Refer to FIG. 1 to FIG. 4. In an embodiment of this application, the first wiring portion 12 includes a pin 121, and a contact 122 is disposed at one end of the pin 121. In the direction in which the first plug-connection module 1 is plugged into the second plug-connection module 2, the contact 122 is located at an end near the second plug-connection module 2. An end that is of the first wiring portion 12 and that is on which the contact 122 is disposed penetrates through the first chamber 112a of the first guide sleeve 112 and then enters the second chamber 112b. The other end of the first wiring portion 12 may be located outside the first guide sleeve 112, and is configured to be connected to an external line.

In an embodiment of this application, a material of the contact 122 may be high-temperature-resistant metal, for example, may be copper or a copper alloy. The copper alloy includes but is not limited to a tungsten copper alloy. The tungsten copper alloy is an alloy consisting of tungsten and copper, with a copper content of 10 wt % to 50 wt %. The tungsten copper alloy may be prepared by using, for example, a powder metallurgy method, and has excellent electrical and thermal conductivity, relatively good high temperature strength, and specific plasticity. At a high temperature, such as a temperature higher than or equal to 3000° C., copper in the tungsten copper alloy is liquefied and evaporated, to absorb a large amount of heat, thereby reducing a material surface temperature.

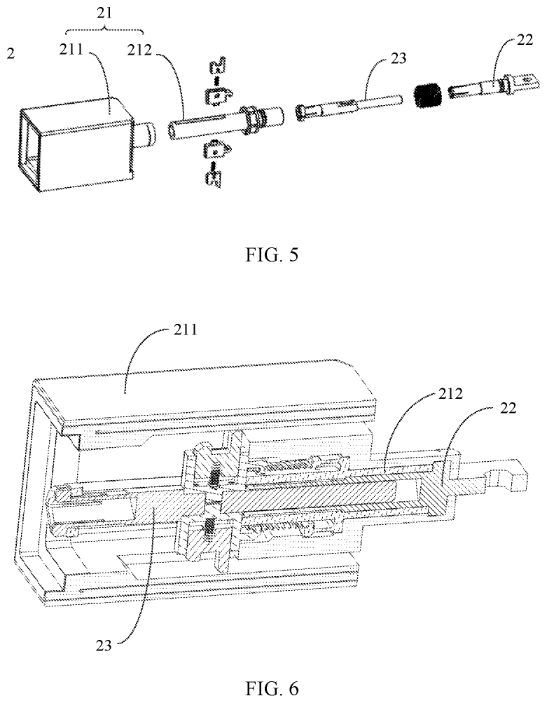

FIG. 5 is a schematic exploded diagram of a structure of the second plug-connection module 2 according to an embodiment of this application. FIG. 6 is a schematic cross-sectional diagram of a structure of the second plug-connection module 2 according to an embodiment of this application. As shown in FIG. 5 and FIG. 6, in an embodiment of this application, the second plug-connection module 2 includes a second housing component 21, and a second wiring portion 22 and a sliding conductor 23 are disposed in the second housing component 21. The second wiring portion 22 is connected to the second housing component 21 through fastening, and the sliding conductor 23 is slidably connected to the second wiring portion 22 in the first direction.

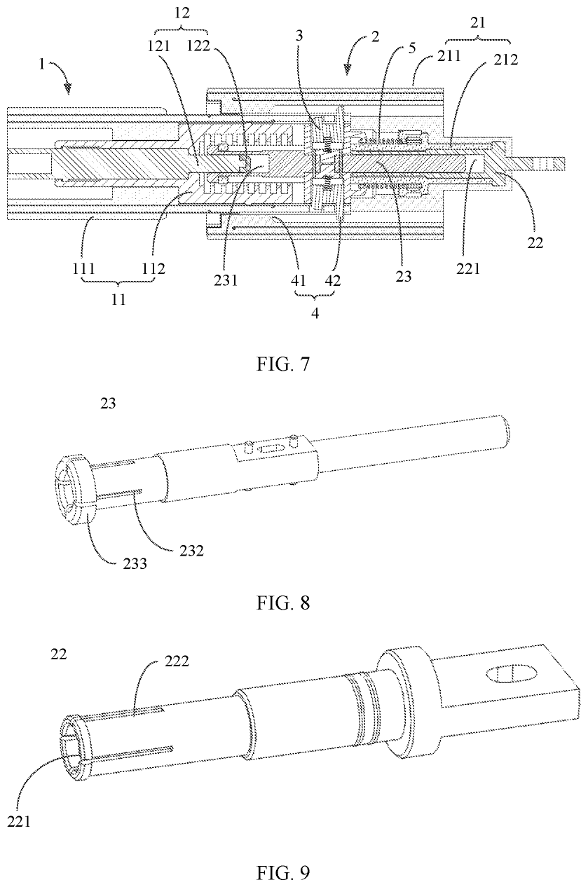

FIG. 7 is a schematic cross-sectional diagram of a structure in which the first plug-connection module 1 is plugged into the second plug-connection module 2 according to an embodiment of this application. With reference to FIG. 5 to FIG. 7, in the direction in which the first plug-connection module 1 is plugged into the second plug-connection module 2, the sliding conductor 23 is located on a side near the first plug-connection module 1. After the first plug-connection module 1 is plugged into the second plug-connection module 2, one end of the sliding conductor 23 is connected to the end that is of the first wiring portion 12 and that is on which the contact 122 is disposed.

As shown in FIG. 5 to FIG. 7, in an embodiment of this application, an end that is of the sliding conductor 23 and that is configured to be connected to the first wiring portion 12 is a hollow structure, to form a first sliding hole 231 that fits with the first wiring portion 12. When the first plug-connection module 1 and the second plug-connection module 2 are in a plugged state, the end that is of the first wiring portion 12 and that is on which the contact 122 is disposed is plugged into the first sliding hole 231. An outer diameter of the first wiring portion 12 is almost consistent with an inner diameter of the first sliding hole 231, so that the first wiring portion 12 and the first sliding hole 231 are connected to each other through clamping by relying on friction between the first wiring portion 12 and the first sliding hole 231, thereby implementing electrical connection.

It may be understood that, in an embodiment of this application, the end that is of the first wiring portion 12 and that is on which the contact 122 is disposed may be disposed as a pyramidal structure, and an outer diameter of the contact 122 is slightly smaller, to facilitate plugging of the first wiring portion 12 into the first sliding hole 231 in a plugging process.

In addition, FIG. 8 is a schematic diagram of a structure of the sliding conductor 23 according to an embodiment of this application. As shown in FIG. 7 and FIG. 8, a first split groove 232 is disposed at an end portion that is of the sliding conductor 23 and that is configured to be connected to the first wiring portion 12. The first split groove 232 is disposed, so that the end portion of the sliding conductor 23 can be correspondingly deformed when being plug-connected to the first wiring portion 12. In addition, friction between the sliding conductor 23 and the first wiring portion 12 is reduced, to reduce plug-connection resistance, thereby facilitating plugging of the first wiring portion 12 into the first sliding hole 231. In an embodiment of this application, a stiffener 233 may be disposed at an end portion of the first split groove 232. The stiffener 233 may be, for example, a flange formed at the end portion of the first split groove 232, or may be a structure such as a steel sheet disposed at the end portion of the first split groove 232, to improve strength of the end portion of the sliding conductor 23 at a plugging opening. It may be understood that, in addition to the manner in which the first split groove 232 is disposed, a connection structure such as a wire spring or a leaf spring may be alternatively disposed at the end portion that is of the sliding conductor 23 and that is configured to be connected to the first wiring portion 12, to implement connection to the first wiring portion 12.

Still refer to FIG. 8. The other side that is of the sliding conductor 23 and that is opposite to the first sliding hole 231 may be a solid columnar structure, and the side is configured to be connected to the second wiring portion 22.

FIG. 9 is a schematic diagram of a structure of the second wiring portion 22 according to an embodiment of this application. Refer to FIG. 7 and FIG. 9. In an embodiment of this application, an end that is of the second wiring portion 22 and that is near the sliding conductor 23 is a hollow structure, to form a second sliding hole 221 for plugging the sliding conductor 23. A second split groove 222 is disposed at an end portion of the second sliding hole 221. The second split groove 222 is disposed, so that the end portion of the second sliding hole 221 can be correspondingly deformed when being plug-connected to the sliding conductor 23. In addition, friction between the sliding conductor 23 and the second wiring portion 22 is reduced, to reduce insertion resistance, thereby facilitating plugging of the sliding conductor 23 into the second sliding hole 221.

In addition, refer to FIG. 7 and FIG. 9. In an embodiment of this application, a wiring terminal 223 is disposed on a side that is of the second wiring portion 22 and that is away from the sliding conductor 23, and the wiring terminal 223 protrudes from the second housing component 21 and is configured to be connected to an external line.

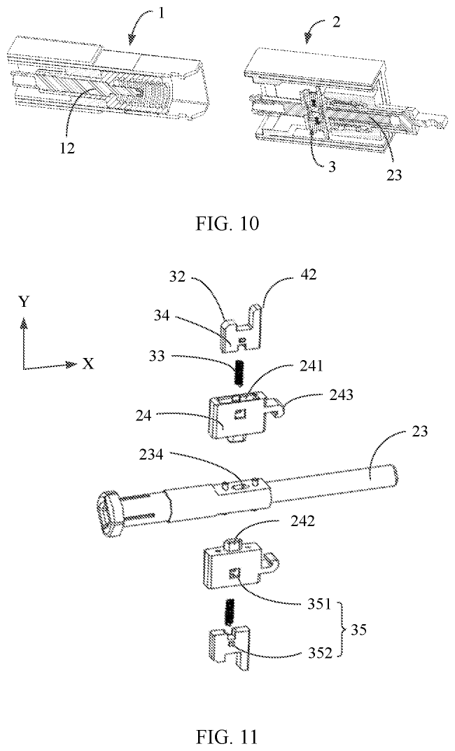

FIG. 10 is a schematic cross-sectional diagram of a structure in which the first plug-connection module 1 and the second plug-connection module 2 are in a separated state according to an embodiment of this application. Refer to FIG. 7 and FIG. 10. To enable the first plug-connection module 1 and the second plug-connection module 2 to be in a stable connected state after the first plug-connection module 1 is plugged into the second plug-connection module 2, in an embodiment of this application, a locking mechanism 3 is disposed between the first plug-connection module 1 and the second plug-connection module 2. When the locking mechanism 3 is in a locked state, the locking mechanism 3 locks the sliding conductor 23 and the first wiring portion 12, to keep the sliding conductor 23 connected to the first wiring portion 12; or when the locking mechanism 3 is in an unlocked state, locking between the sliding conductor 23 and the first wiring portion 12 is released, and in this case, the sliding conductor 23 can be separated from the first wiring portion 12.

FIG. 11 is a schematic exploded diagram of a structure of the locking mechanism 3 according to an embodiment of this application. Refer to FIG. 3, FIG. 10, and FIG. 11. In an embodiment of this application, the locking mechanism 3 includes a locking hole 31, a first convex lug 32, and an elastic body 33.

As shown in FIG. 3, the locking hole 31 is disposed in the first insulation housing 111, and the locking hole 31 may be a through hole or a blind hole. It may be understood that the locking hole 31 may be a square hole or a circular hole, or of another shape. This is not specifically limited herein.

Refer to FIG. 3, FIG. 10, and FIG. 11. The first convex lug 32 in the locking mechanism 3 is connected to the sliding conductor 23, and the first convex lug 32 protrudes in a second direction and can reciprocate near or away from the sliding conductor 23 in the second direction. The second direction is perpendicular to the first direction, and is, for example, a Y direction in FIG. 11. When the first convex lug 32 is inserted into the locking hole 31, the locking mechanism 3 is in the locked state; or when the first convex lug 32 is detached from the locking hole 31, the locking mechanism 3 is in the unlocked state. A wedge-shaped surface may be disposed at an end portion that is of the first convex lug 32 and that is away from the sliding conductor 23, to facilitate insertion of the first convex lug 32 into the locking hole 31.

When the first convex lug 32 is detached from the locking hole 31, the elastic body 33 is in a force accumulation state, to provide the first convex lug 32 with a force for enabling the first convex lug 32 to move in a direction oppositely to a surface of the sliding conductor 23. The elastic body 33 may be a spring, and in addition, may be alternatively a spring plate. The first convex lug 32 moves in a direction away from the sliding conductor 23 in the second direction under the action of the elastic body 33. When a combined force received by the first convex lug 32 is directed to the sliding conductor 23, the first convex lug 32 may alternatively move in a direction near the sliding conductor 23 in the second direction.

Still refer to FIG. 11. In an embodiment of this application, the locking mechanism 3 further includes a lock body 34, and the lock body 34 can be movably mounted on the sliding conductor 23 in the second direction, so that the lock body 34 can move relative to the sliding conductor 23 in the second direction. The first convex lug 32 is connected to the lock body 34 through fastening, and is located on a side that is of the lock body 34 and that is away from the sliding conductor 23. The elastic body 33 is disposed between the lock body 34 and the sliding conductor 23, so that the lock body 34 can reciprocate in the second direction. Refer to FIG. 7 and FIG. 11 together. In the structure, in a process in which the first plug-connection module 1 is plugged into the second plug-connection module 2, the elastic body 33 drives the lock body 34 to move, and the lock body 34 drives the first convex lug 32 to move. In a process in which the first plug-connection module 1 is separated from the second plug-connection module 2, the lock body 34 drives the first convex lug 32 to move and press the elastic body 33.

Still refer to FIG. 11. In an embodiment of this application, a peripheral side surface of the sliding conductor 23 is connected to a base 24 through fastening, a sliding slot 241 extending in the second direction is disposed in the base 24, an opening of the sliding slot 241 is located on a side opposite to the sliding conductor 23, and the lock body 34 is disposed in the sliding slot 241 and slidably fits with the base 24. The elastic body 33 is disposed between the lock body 34 and the base 24. In the structure, the lock body 34 moves in the sliding slot 241 in the second direction, to improve operating stability of the lock body 34. In addition, in an embodiment of this application, as shown in FIG. 11, a mounting hole 234 is disposed in the sliding conductor 23, and correspondingly, a mounting post 242 is disposed at a bottom portion of the base 24. During mounting, the mounting post 242 of the base 24 may be fastened to the mounting hole 234 of the sliding conductor 23, so that the base 24 is connected through fastening relative to the sliding conductor 23.

In addition, as shown in FIG. 11, in an embodiment of this application, a limiting mechanism 35 is disposed between the sliding slot 241 and the lock body 34, and the limiting mechanism 35 is configured to limit a maximum sliding stroke of the lock body 34 relative to the base 24. The limiting mechanism 35 includes a limiting hole 351 disposed on a wall of the sliding slot 241, and a limiting protrusion 352 disposed on a side surface of the lock body 34. The limiting protrusion 352 is disposed in the limiting hole 351, and the limiting protrusion 352 can move in the limiting hole 351 in the second direction. The limiting mechanism 35 can prevent an excessively large movement stoke of the lock body 34 relative to the base 24, to prevent the lock body 34 from being detached from the sliding slot 241.

Still refer to FIG. 7, FIG. 10, and FIG. 11. When the first plug-connection module 1 needs to be separated from the second plug-connection module 2, to detach the first convex lug 32 from the locking hole 31, in an embodiment of this application, the electrical connector further includes a trigger mechanism 4. The trigger mechanism 4 includes a second convex lug 42 and a guide portion 41, and the guide portion 41 is configured to apply a force to the second convex lug 42, so that the second convex lug 42 can move in the direction near the sliding conductor 23. The second convex lug 42 protrudes in the second direction, and therefore is consistent with the first convex lug 32 in protrusion direction. The second convex lug 42 is connected to the sliding conductor 23 and is disposed through fastening relative to the first convex lug 32, so that the second convex lug 42 can also reciprocate near or away from the sliding conductor 23 in the second direction. When moving, the second convex lug 42 can drive the first convex lug 32 to move. For example, when moving in the direction near the sliding conductor 23, the second convex lug 42 can drive the first convex lug 32 to move in the direction near the sliding conductor 23.

In the second direction, a protrusion height of the second convex lug 42 is greater than a protrusion height of the first convex lug 32, and a height difference between the second convex lug 42 and the first convex lug 32 is greater than a height of the locking hole 31. When the guide portion 41 applies pressure to the second convex lug 42 to enable the second convex lug 42 to move in the direction near the sliding conductor 23, due to setting of the height difference, the first convex lug 32 can be detached from the locking hole 31, to unlock the locking mechanism 3.

When the first convex lug 32 is located in the locking hole 31, the second convex lug 42 is located outside the first housing component 11, for example, at an edge of the first housing component 11. Also refer to FIG. 2. A gap 111a may be disposed at the edge of the first insulation housing 111. When the first convex lug 32 is located in the locking hole 31, the second convex lug 42 may be located at the gap 111a, to reduce occupied space of the electrical connector in the first direction.

Refer to FIG. 7. The guide portion 41 may be a convex surface formed on a surface of the second housing component 21. As an example description, the guide portion 41 may be a wedge-shaped convex surface. In the process in which the first plug-connection module 1 is separated from the second plug-connection module 2, the second housing component 21 gradually moves in a direction away from the first housing component 11 in the first direction. After the second housing component 21 reaches a preset position after moving by a preset distance, the guide portion 41 can move to the second convex lug 42 to apply pressure to the second convex lug 42, so that the second convex lug 42 moves in the direction near the sliding conductor 23.

Still refer to FIG. 11. In an embodiment of this application, the second convex lug 42 is connected to the lock body 34 through fastening, and is located on the side that is of the lock body 34 and that is away from the sliding conductor 23 and therefore is located on the same side as the first convex lug 32. In a process of driving the first convex lug 32 to move, the lock body 34 also drives the second convex lug 42 to move. In the process in which the first plug-connection module 1 is separated from the second plug-connection module 2, the second convex lug 42 is pressed to drive the lock body 34 to move, and the lock body 34 drives the first convex lug 32 to move and press the elastic body 33.

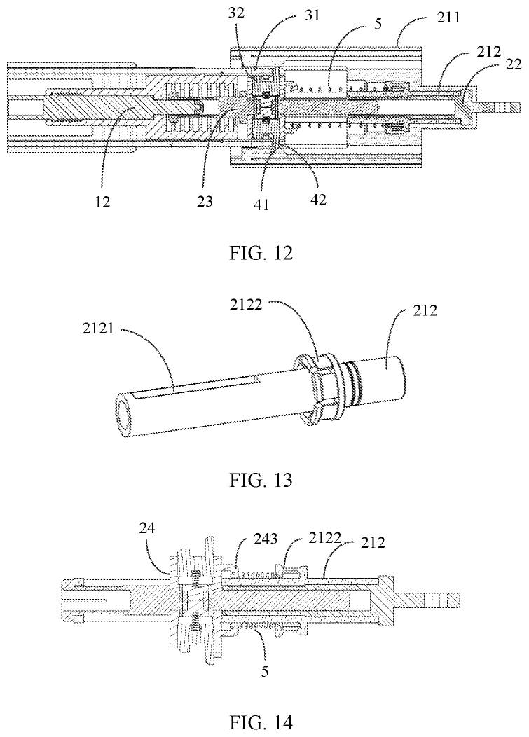

FIG. 12 is a schematic diagram of a structure in which the first convex lug is detached from the locking hole according to an embodiment of this application. Refer to FIG. 7 and FIG. 12. When the guide portion 41 applies pressure to the second convex lug 42 and the first convex lug 32 is driven by the second convex lug 42 to be detached from the locking hole 31, the locking mechanism 3 is in the unlocked state. In this case, the sliding conductor 23 is connected to the first wiring portion 12 by relying on friction between the sliding conductor 23 and the first wiring portion 12. To enable the sliding conductor 23 to be fast separated from the first wiring portion 12, the electrical connector further includes an elastic reset member 5. The elastic reset member 5 may be a spring. One end of the elastic reset member 5 is connected to the second housing component 21, and the other end of the elastic reset member 5 is connected to the sliding conductor 23. When the first convex lug 32 is detached from the locking hole 31, the elastic reset member 5 is in a force accumulation state, and a force applied by the elastic reset member 5 to the sliding conductor 23 is directed away from the first wiring portion 12, so that the sliding conductor 23 is driven to operate in the first direction and return to an initial state of the sliding conductor 23 in the second housing component 21, to separate the sliding conductor 23 from the first wiring portion 12.

Refer to FIG. 7 and FIG. 12. In an embodiment of this application, the second housing component 21 includes a second insulation housing 211 and a second guide sleeve 212, and the second guide sleeve 212 is disposed inside the second insulation housing 211 and is connected to the second insulation housing 211 through fastening. The second guide sleeve 212 is disposed outside the sliding conductor 23 and the second wiring portion 22 through encasing, and the sliding conductor 23 is slidably connected to the second guide sleeve 212 in the first direction. The stiffener 233 at the first split groove 232 of the sliding conductor 23 may be further used as a stop protrusion, to limit a displacement stroke of the second guide sleeve 212 relative to the sliding conductor 23 in the first direction.

FIG. 13 is a schematic diagram of a structure of the second guide sleeve 212 according to an embodiment of this application. As shown in FIG. 13, a guide hole 2121 is disposed in the second guide sleeve 212, the guide hole 2121 is a strip-shaped structure, and a length direction of the guide hole 2121 is the first direction. With reference to FIG. 11 and FIG. 13, the base 24 penetrates through the guide hole 2121 to be connected to the sliding conductor 23 through fastening. Also refer to FIG. 7. In a process in which the first insulation housing 111 and the second insulation housing 211 are separated from each other, the second guide sleeve 212 moves together with the second insulation housing 211 in a direction away from the first plug-connection module 1, and positions of the base 24 and the sliding conductor 23 are fixed.

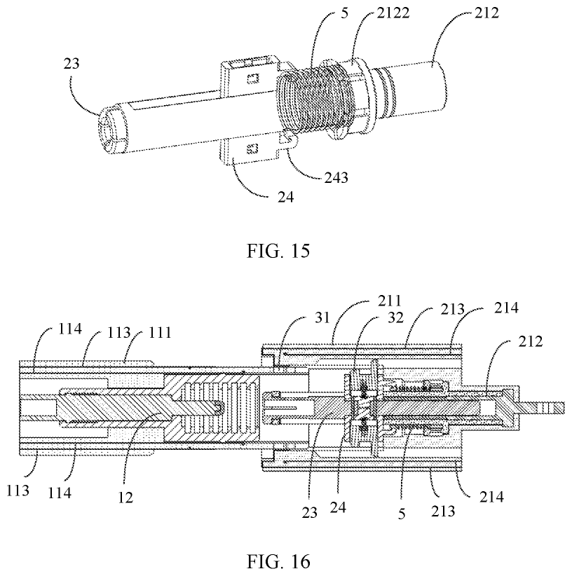

FIG. 14 is a schematic cross-sectional diagram of a structure of a connection relationship of the elastic reset member according to an embodiment of this application. FIG. 15 is a schematic diagram of a structure of the connection relationship of the elastic reset member. Refer to FIG. 14 and FIG. 15. In an embodiment of this application, one end of the elastic reset member 5 is connected to the second guide sleeve 212 through fastening, and the other end of the elastic reset member 5 is connected to the base 24 through fastening. A first fastener 2122 is disposed on the second guide sleeve 212, a second fastener 243 is disposed on the base 24, and the two ends of the elastic reset member 5 are respectively connected to the first fastener 2122 and the second fastener 243.

Refer to FIG. 11 and FIG. 14. In an embodiment of this application, in the first direction, the second fastener 243 is disposed on a side portion of the base 24 and is located on a side that is of the base 24 and that is away from the first sliding hole 231. The second fastener 243 may be, for example, a convex hook, to fasten the elastic reset member 5. The first fastener 2122 is disposed on a peripheral side surface of the second guide sleeve 212. As shown in FIG. 11 and FIG. 14, the first fastener 2122 may also be a hook structure, and may be continuously arranged along the peripheral side surface of the second guide sleeve 212. The elastic reset member 5 is disposed outside the second guide sleeve 212 through sleeving and is located between the first fastener 2122 and the second fastener 243.

For example, the elastic reset member 5 is a spring. When the base 24 is located at an end that is of the guide hole 2121 and that is near the second wiring portion 22, a position of the sliding conductor 23 relative to the second guide sleeve 212 is in the initial state and is in a stable state, and the elastic reset member 5 may be in a non-force accumulation state or the force accumulation state; or when the base 24 is located at an end that is of the guide hole 2121 and that is away from the second wiring portion 22, the elastic reset member 5 is in a stretched force accumulation state, to provide power for a return movement of the base 24.

FIG. 16 is a schematic diagram of a structure in which the sliding conductor returns to the initial state according to an embodiment of this application. As shown in FIG. 16, when the first convex lug 32 is detached from the locking hole 31, the sliding conductor 23 returns to the initial state in the second guide sleeve 212 under the action of the elastic reset member 5. In this case, a distance between the first wiring portion 12 and the sliding conductor 23 is greater than an arc extinguishing distance between the first wiring portion 12 and the sliding conductor 23. The arc extinguishing distance may be understood as a distance that can extinguish an electric arc between the first wiring portion 12 and the sliding conductor 23. The arc extinguishing distance between the first wiring portion 12 and the sliding conductor 23 may be determined based on specific potentials connected to the first wiring portion 12 and the sliding conductor 23. In addition, the arc extinguishing distance is further related to disposition of the arc extinguishing grids in the arc extinguishing chamber. A larger potential difference between the first wiring portion 12 and the sliding conductor 23 indicates a larger required arc extinguishing distance. In addition, as shown in FIG. 15, when the sliding conductor 23 returns to the second guide sleeve 212, the end portion of the sliding conductor 23 may be located in the arc extinguishing chamber of the first guide sleeve 112, or may be located at an edge of the arc extinguishing chamber, to prevent electric arc leakage.

When the electrical connector in embodiments of this application is used as a medium-voltage plug connector, the electrical connector is usually mounted at a rear end of a power/signal module of a product, to implement drawer-type plugging/unplugging for use. In a medium-voltage hot swap process, electric arcs may be generated in both plugging and unplugging processes. In the plugging process, due to a good air state (that is, there are no diffused charged ions or particles in the air), an electric arc is generated only when a plugging distance is extremely short (about 10 mm is obtained through actual measurement at 10 kV). When a plugging action is actually performed, because the module is relatively heavy, relatively large inertia exists in an actual pushing process. When a rear end distance is extremely short, fast pushing is implemented. The pushing usually can be completed at the distance within 1 s. Therefore, impact of an electric arc generated in the process can be ignored. In the unplugging process, because the module is relatively heavy, if fast pulling cannot be implemented, in a slow pulling process, due to an extremely short distance of or a discharge electric arc generated on a front end of the connector, and due to a relatively low movement speed, copper in a conductor may be vaporized at an extremely high temperature of the electric arc, and a large quantity of conductive ions/particles are generated in the air. As a result, an arc extinguishing distance of a terminal is increased to an extremely large degree. In addition, arc extinguishing can be implemented only when the terminal is separated relatively far enough, and the electric arc climbs with the conductive ions/particles. This is likely to implicate a surrounding structure, causing a second accident. However, the electrical connector in this application can implement fast separation in a hot swap case.

The following briefly describes a separation process of the electrical connector in this application with reference to FIG. 7, FIG. 12, and FIG. 16.

First, refer to FIG. 7. When the first plug-connection module 1 and the second plug-connection module 2 are in the plugged state, the first convex lug 32 of the locking mechanism 3 is located in the locking hole 31, and the first wiring portion 12 is plugged into the first sliding hole 231 of the sliding conductor 23. The first plug-connection module 1 is fixed, and the second plug-connection module 2 is pulled to move in the direction away from the first plug-connection module 1. In this case, a position of the first wiring portion 12 relative to the sliding conductor 23 remains unchanged, and the second insulation housing 211, the second guide sleeve 212, and the second wiring portion 22 move in a direction away from the first wiring portion 12. A spring used as the elastic reset member 5 is stretched.

Refer to FIG. 12. After the second insulation housing 211, the second guide sleeve 212, and the second wiring portion 22 move by a specific distance, the guide portion 41 on an inner surface of the second insulation housing 211 moves to a position of the second convex lug 42 and presses the second convex lug 42, so that the second convex lug 42 moves in the direction near the sliding conductor 23. When moving, the second convex lug 42 drives the first convex lug 32 to move, to detach the first convex lug 32 from the locking hole 31.

Refer to FIG. 16. After the first convex lug 32 is detached from the locking hole 31, the elastic reset member 5 has been stretched to a specific length, and a force generated by the elastic reset member 5 on the sliding conductor 23 through the base 24 is far greater than friction between the first wiring portion 12 and the sliding conductor 23. Then, under the action of a recovery force of the elastic reset member 5, the sliding conductor 23 is driven to return to an initial position, to fast separate the first wiring portion 12 from the sliding conductor 23.

Because a current flowing through the first wiring portion 12 and the sliding conductor 23 is an alternating current, an electrical change rule for generating an electric arc between the first wiring portion 12 and the sliding conductor 23 is: generation→0 point→generation. When an electric arc generated between the first wiring portion 12 and the sliding conductor 23 is just at the 0 point, air insulation strength is greater than voltage breakdown strength of the electric arc, so that the electric arc can be extinguished. If the first wiring portion 12 is separated from the sliding conductor 23 excessively slowly, an electric arc is generated between the first wiring portion 12 and the sliding conductor 23 for long time. In this case, air insulation strength is affected. However, in the technical solutions provided in embodiments of this application, the first wiring portion 12 can be fast separated from the sliding conductor 23, thereby reducing impact of an electric arc on air insulation strength.

In addition, an electric arc generated in the process in which the first wiring portion 12 is separated from the sliding conductor 23 may act on the contact 122 of the first wiring portion 12 and the end portion of the sliding conductor 23. In particular, the contact 122 and the end portion of the sliding conductor 23 may be made of a copper tungsten alloy, and the copper tungsten alloy has an extremely high heat-resistant characteristic. Therefore, the first wiring portion 12 and the sliding conductor 23 are not damaged.

In addition, an electric arc generated between the first wiring portion 12 and the sliding conductor 23 passes through the arc extinguishing grids 1121. The arc extinguishing grids 1121 can cut one long electric arc into a plurality of short electric arcs. When an alternating current flows through a zero point, all the short electric arcs are simultaneously extinguished. Due to a near cathode effect, start dielectric strength of a specific voltage immediately appears near a cathode of each short electric arc. Provided that a start dielectric strength sum obtained after all the short electric arcs are connected in series is greater than a voltage between the first wiring portion 12 and the sliding conductor 23, the electric arc no longer reignites, to implement arc extinguishing. In a process in which the first wiring portion 12 is separated and pulled out from the sliding conductor 23, all electric arcs generated between the first wiring portion 12 and the sliding conductor 23 are limited inside the first housing component 11 and the second housing component 21. Therefore, the electric arcs are not leaked, to implement safety and reliability.

The electrical connector in embodiments of this application is in a medium-voltage electric field environment in a use process. Due to pointing from a high-voltage side to a low-voltage side in terms of voltage, in a path from a middle voltage to a low voltage, it should be noted that partial discharge may be caused in a case of extremely little air. A hazard of the partial discharge is mainly reflected in a damage effect on an insulation structure, for example, the first housing component and the second housing component. If the partial discharge continuously develops, deterioration and damage of an insulation material are gradually expanded, and finally a normal life of the insulation structure is shortened, short-term insulation strength is reduced, and even the entire insulation structure may be broken down. To prevent partial discharge from being caused in use of the electrical connector in embodiments of this application, in an embodiment of this application, in an embodiment of this application, a homogenized electric field is designed for the electrical connector.

There are mainly three manners of processing partial discharge from a medium voltage to a low voltage. In a first manner, an enough air distance is kept between a medium voltage and a low voltage. In this case, due to a relatively large air distance, it is difficult to cause partial discharge. However, this design requires a large product volume and has strong product design limitation. For example, in a case of 10 kV, a difference of an insulation housing of a live electrical connector from zero-potential sheet metal needs to be greater than or equal to 90 mm. In a second manner, partial discharge is controlled by using a combination of air and a solid insulation medium. A specific solid insulation material may be disposed between a medium voltage and a low voltage for blocking. In this case, a required air insulation distance can be greatly reduced. However, a valid air distance still needs to be greater than or equal to 25 mm, and a relatively large quantity of limitations are imposed on an actual design of an entire product. In a third manner, partial discharge is controlled by using a solid insulation medium. Glue filling or equipotential processing is performed on medium voltage and low voltage parts, to ensure that there is no extremely little air between a medium voltage and a low voltage, so that an electric field from the medium voltage to the low voltage can be applied to a solid insulation material. Insulation strength of the solid insulation material may be implemented by selecting different insulation materials, so that a volume of an entire design can be further reduced.

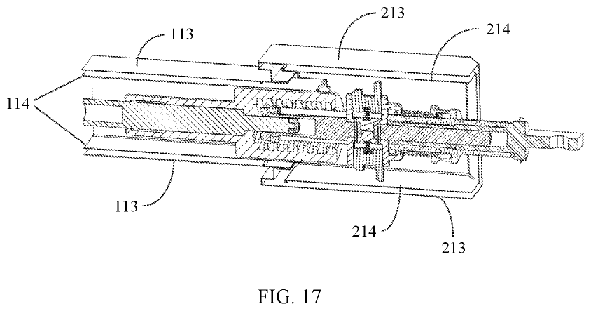

FIG. 17 is a schematic diagram of a structure in which a first insulation housing and a second insulation housing of an electrical connector are hid according to an embodiment of this application. Refer to FIG. 16 and FIG. 17. To prevent partial discharge from being caused in a use process of the electrical connector, an embodiment of this application provides an electrical connector. A first metal layer 113 and a second metal layer 114 are embedded in a first insulation housing 111. The first metal layer 113 is disposed near an outer surface of the first insulation housing 111, the second metal layer 114 is disposed inside the first insulation housing 111, the first metal layer 113 is connected to a zero potential, and the second metal layer 114 is equipotentially connected to a first wiring portion 12. A thickness of the first insulation housing 111 between the first metal layer 113 and the second metal layer 114 needs to be greater than an insulation requirement, to prevent the first insulation housing 111 between the first metal layer 113 and the second metal layer 114 from being broken down. Therefore, a medium voltage→low voltage electric field can be transferred to the first insulation housing 111. The first metal layer 113 is connected to a low-voltage potential point, and the second metal layer 114 is connected to a middle-voltage potential point. Both the first metal layer 113 and the second metal layer 114 may be connected to the potential points by using bumps or wires, and the connections are used as only equipotential connections, to implement voltage consistency. In this manner, a problem of air partial discharge inside the electrical connector is resolved.

A third metal layer 213 and a fourth metal layer 214 are embedded in a second insulation housing 211, the third metal layer 213 is disposed near an outer surface of the second insulation housing 211, the fourth metal layer 214 is disposed inside the second insulation housing 211, the third metal layer 213 is connected to a zero potential, and a potential of the fourth metal layer 214 is equipotentially connected to a second wiring portion 22. A thickness of the second insulation housing 211 between the third metal layer 213 and the fourth metal layer 214 needs to be greater than an insulation requirement, to prevent the second insulation housing 211 between the third metal layer 213 and the fourth metal layer 214 from being broken down. Therefore, a medium voltage→low voltage electric field can be transferred to the second insulation housing 211. The third metal layer 213 is connected to a low-voltage potential point, and the fourth metal layer 214 is connected to a middle-voltage potential point. Both the third metal layer 213 and the fourth metal layer 214 may be connected to the potential points by using bumps or wires, and the connections are used as only equipotential connections, to implement voltage consistency. In this manner, a problem of air partial discharge inside the electrical connector is resolved.

According to the homogenized electric field design in the foregoing embodiment of this application, a space requirement for an entire system in which the electrical connector is used can be reduced, so that the entire system is more conveniently designed, and a smaller entire system can be designed.

Based on a same technical concept, this application provides electrical equipment in an embodiment. The electrical equipment includes a first circuit unit, a second circuit unit, and the electrical connector in the first aspect of this application. The first wiring portion is connected to the first circuit unit, and the second wiring portion is connected to the second circuit unit.

It may be understood that at least two electrical connectors may be disposed between the first circuit unit and the second circuit unit in this application, to form an electrical connection loop.

The electrical equipment in this embodiment of this application includes the electrical connector in the foregoing embodiments of this application. When the electrical connector in this application has a hot swap function, a function module corresponding to the first circuit unit or the second circuit unit in the electrical equipment in this application can be overhauled and maintained under a condition of a weak current, for example, a current lower than 500 mA or lower than 300 mA, thereby improving overhaul and maintenance efficiency, and reducing maintenance time. The weak current is merely an example description rather than a specific limitation, and may be specifically determined based on a specific application range of the electrical equipment and a value of a current used by the electrical equipment.

The foregoing description is merely a specific implementation of this application, but is not intended to limit the protection scope of this application. Any variation or replacement readily figured out by a person skilled in the art within the technical scope disclosed in this application shall fall within the protection scope of this application recited in the claims.

1. An electrical connector, comprising:
a first plug-connection module;
a second plug-connection module, wherein the first plug-connection module fits with the second plug-connection module through a plug-connection in a first direction,
wherein the first plug-connection module comprises a first housing component, and a first wiring portion that is disposed in the first housing component; and the second plug-connection module comprises a second housing component, a second wiring portion and a sliding conductor that are disposed in the second housing component, wherein the sliding conductor is slidably connected to the second wiring portion in the first direction, and wherein the second wiring portion is connected to the second housing component through fastening;
a locking mechanism;
a trigger mechanism, wherein the locking mechanism and the trigger mechanism are disposed between the first plug-connection module and the second plug-connection module; and while the locking mechanism is in a locked state, the locking mechanism locks the sliding conductor and the first wiring portion, to keep the sliding conductor connected to the first wiring portion; or while the locking mechanism is in an unlocked state, the connection between the sliding conductor and the first wiring portion is released; and
an elastic reset member that is disposed between the second housing component and the sliding conductor; and while the first housing component and the second housing component are moved away from each other to a preset position, the trigger mechanism triggers the locking mechanism to enable the locking mechanism to be in the unlocked state, and the elastic reset member is in a force accumulation state to drive the sliding conductor to move in the first direction, and to separate the sliding conductor from the first wiring portion.

2. The electrical connector according to claim 1, wherein the locking mechanism comprises:
a locking hole disposed in the first housing component;
a first convex lug connected to the sliding conductor, wherein the first convex lug protrudes in a second direction and is capable of moving in the second direction, and wherein the second direction is perpendicular to the first direction; and
an elastic body configured to provide the first convex lug with a force for enabling the first convex lug to move in a direction that is opposite to a surface of the sliding conductor, wherein
while the first convex lug is inserted into the locking hole, the locking mechanism is in the locked state; or while the first convex lug is detached from the locking hole, the locking mechanism is in the unlocked state.

3. The electrical connector according to claim 2, wherein the locking hole is a through hole or a blind hole.

4. The electrical connector according to claim 2, wherein the trigger mechanism comprises:
a second convex lug that protrudes in the second direction and that is connected to the sliding conductor, wherein the second convex lug is disposed through fastening relative to the first convex lug, a protrusion height of the second convex lug is greater than a protrusion height of the first convex lug, and a height difference between the second convex lug and the first convex lug is greater than a height of the locking hole; and
a guide portion formed in the second housing component, wherein in a process in which the first plug-connection module is detached from the second plug-connection module, while the first housing component and the second housing component are moved away from each other to the preset position, the guide portion abuts against the second convex lug to press the second convex lug to an unlocked position, and wherein the second convex lug drives the first convex lug to detach the first convex lug from the locking hole.

5. The electrical connector according to claim 2, wherein the locking mechanism further comprises a lock body, the first convex lug and the second convex lug are fastened to the lock body, the lock body is connected to the sliding conductor, the elastic body is disposed between the lock body and the sliding conductor, and the lock body moves relative to the sliding conductor in the second direction.

6. The electrical connector according to claim 5, wherein a base is connected to a peripheral side surface of the sliding conductor through fastening, a sliding slot extending in the second direction is disposed in the base, and the lock body slidably fits with the base through the sliding slot.

7. The electrical connector according to claim 6, wherein the elastic body is disposed between the lock body and the base, and two ends of the elastic body respectively abut against the lock body and the base.

8. The electrical connector according to claim 6, wherein a limiting mechanism is disposed between the sliding slot and the lock body, and the limiting mechanism is configured to limit a maximum sliding stroke of the lock body relative to the base.

9. The electrical connector according to claim 1, wherein the first wiring portion comprises a pin, and a contact that is disposed at an end of the pin and that is configured to be connected to the sliding conductor.

10. The electrical connector according to claim 9, wherein a material of the contact is copper or a copper alloy.

11. The electrical connector according to claim 1, wherein the first housing component comprises a first insulation housing and a first guide sleeve that is disposed in the first insulation housing and that is connected to the first insulation housing through fastening, and wherein one end of the first wiring portion is disposed in the first guide sleeve.

12. The electrical connector according to claim 11, wherein an arc extinguishing chamber is disposed in the first guide sleeve, and an end of the first wiring portion that is configured to be connected to the sliding conductor is located in the arc extinguishing chamber.

13. The electrical connector according to claim 12, wherein a plurality of arc extinguishing grids spaced at intervals are disposed on an inner surface of the arc extinguishing chamber.

14. The electrical connector according to claim 13, wherein each of the plurality of arc extinguishing grids is an annular protrusion that is circumferentially disposed along an inner surface of the first guide sleeve.

15. The electrical connector according to claim 14, wherein a cross-section of each of the plurality of arc extinguishing grids is rectangular, trapezoidal, or arc-shaped.

16. The electrical connector according to claim 11, wherein the first housing component comprises a first metal layer and a second metal layer that are embedded in the first insulation housing, the second metal layer is disposed inside the first insulation housing, the first metal layer is disposed near an outer surface of the first insulation housing relative to the second metal layer, wherein the first metal layer is connected to a zero potential, and wherein the second metal layer is equipotentially connected to the first wiring portion.

17. The electrical connector according to claim 1, wherein a first sliding hole that fits with the first wiring portion is disposed at an end of the sliding conductor that is configured to be connected to the first wiring portion.

18. The electrical connector according to claim 1, wherein the second housing component comprises a second insulation housing, and a second sliding hole that is disposed at an end of the second wiring portion that is configured to be connected to the sliding conductor.

19. The electrical connector according to claim 18, wherein a wiring terminal is disposed on a side of the second wiring portion that is away from the sliding conductor, and wherein the wiring terminal protrudes from the second insulation housing and is configured to be connected to an external line.

20. Electrical equipment, comprising:
a first circuit unit;
a second circuit unit; and
an electrical connector,
wherein the electrical connector comprises a first plug-connection module and a second plug-connection module, wherein the first plug-connection module fits with the second plug-connection module through a plug-connection in a first direction,
wherein the first plug-connection module comprises a first housing component, and a first wiring portion that is disposed in the first housing component; and the second plug-connection module comprises a second housing component, a second wiring portion and a sliding conductor that are disposed in the second housing component, wherein the sliding conductor is slidably connected to the second wiring portion in the first direction, and wherein the second wiring portion is connected to the second housing component through fastening;
a locking mechanism;
a trigger mechanism, wherein the locking mechanism and the trigger mechanism are disposed between the first plug-connection module and the second plug-connection module; and while the locking mechanism is in a locked state, the locking mechanism locks the sliding conductor and the first wiring portion, to keep the sliding conductor connected to the first wiring portion; or while the locking mechanism is in an unlocked state, the connection between the sliding conductor and the first wiring portion is released; and
an elastic reset member that is disposed between the second housing component and the sliding conductor; and while the first housing component and the second housing component are moved away from each other to a preset position, the trigger mechanism triggers the locking mechanism to enable the locking mechanism to be in the unlocked state, and the elastic reset member is in a force accumulation state to drive the sliding conductor to move in the first direction, and to separate the sliding conductor from the first wiring portion, and
wherein the first wiring portion is connected to the first circuit unit, and the second wiring portion is connected to the second circuit unit.
